(19) United States
(12) Patent Application Publication
(10) Pub. No.: US 2002/0070164 A1
(43) Pub. Date: Jun. 13, 2002

(54) Aeration device for water and a method for aerating water

(75) Inventor: Heribert Josef Henrich, Pfaffikon (CH)

Correspondence Address: SHOEMAKER AND MATTARE, LTD., Suite 1203 Crystal Plaza Bldg. 1, 2001 Jefferson Davis Highway, P.O. Box 2286, Arlington, VA, 22202-0286, US

(73) Assignee: Huber & Suhner AG, Tumbelenstrasse (CH)

(21) Appl. No.: 09/801,667

(22) Filed: Mar. 9, 2001

(30) Foreign Application Priority Data
Dec. 11, 2000 (EP) 00127097.4

(51) Int. Cl. C02F 3/02

(52) U.S. Cl. 210/620; 210/220

(57) ABSTRACT

An aeration device for water, in particular waste water, consists of at least one aerator (1) assembled in a water basin (3), for introducing air bubbles into the water, said air bubbles rising in the water and forming an aeration field, and it consists of at least one guide wall (2, 2′), said guide wall (2, 2′) guiding the up-flow of the air bubbles.

An aeration device for water and a method for aerating water The invention relates to an aeration device for water, in particular for waste water and it relates to a method for aerating water, in particular waste water, according to the definition of the patent claims.

For aerating waste water in sewage works there are known a multitude of various aeration devices. Such aeration devices are assembled on the base of the water basin. They comprise air supply conduits through which air is led and they comprise membranes or porous structures through which air bubbles exit into the waste water. In this manner the water is supplied with oxygen. With respect to design various embodiment forms are differentiated. Thus for example tubular aerators are used with which an air-leading tube is surrounded by a membrane. Alternatively there are known aeration plates which generally consist of a round air-leading support plate and which comprise a membrane fastened on the edge of the support plate. Furthermore roughly rectangular plate aerators are known which comprise a membrane which is fastened in a frame in the manner of a cushion.

The air bubbles exiting from the membranes, on account of their density which is lower in comparison to the waste water, rise against gravity. These air bubbles rising in an up-flow form aeration fields above the aeration devices. In order to achieve as uniform as possible aeration of the waste water in the whole water basin there are applied a multitude of aerators. As a variant to this the aerators are concentrated only in one part of the water basin. Mechanically actuated stirring apparatus propel the water in so-called circulation basins in a longitudinal flow through the aeration field.

The disadvantage with the application of aeration devices is that at the edge of the aeration fields there form rolling currents which non-uniformly fan out the up-flow. This rolling current arises by way of the buoyancy of the rising air bubbles which laterally displace the waste water. The desired uniform aeration of the waste water is thus hindered and there results a limited efficiency of the aeration devices. For avoiding, that is to say for supressing or compensating such rolling currents, aeration devices and stirring apparatus are often over-dimensioned so that excessively many aerators produce an over-dimensioned aeration field, which is reflected in high costs of purchase and maintenance. Also the stirring apparatus used for the flow agitation of the water consume much energy and thus make the aeration method expensive.

It is the object of the present invention to avoid the distadvantages of that which is known, in particular thus to provide an aeration device for water, in particular waste water, and a method for aerating water, in particular waste water, which ensures an efficient and inexpensive distribution of the air bubbles or supply of oxygen. A further object of the invention lies in making available a simple and economically manufacturable aeration device which may be assembled or exchanged without great expense. The aeration device is to consist of individual, standardised construction modules. Existing aeration devices are to be retrofittable in a simple way and manner, thus by way of the assembly of such constructional modules they are to be increasable in their efficieny. Instead of waste water aeration the invention is also to be able to be applied for aerating stagnant waters, such as e.g. natural ponds or ornamental ponds. According to the invention these objects are achieved with an aeration device according to the definition of the patent claims.

The aeration device according to the present invention consists essentially of at least one aerator assembled in a water basin for introducing air bubbles in water. The air bubbles flow up in the water and form an aeration field. At least one guide wall is provided and guides the flowing-up of the air bubbles.

Against the prejudice of the experts who with such a guide wall see an element hindering the flow of the water, the guide wall is applied in the water basin in a directed and controlled manner.

Advantageously the guide wall is arranged laterally on the edge of the aeration field. By way of the existence of the guide wall at the edge of the aeration field a formation of rolling currents is prevented. The rising air bubbles are guided along the guide wall and may not fan out and form rolling currents. By way of incorporating at least one guide wall in a water basin thus the efficiency of the aeration device may be increased. Existing aeration devices may in a simple way and manner be retro-fitted with guide walls, new aeration devices may be designed re-dimensioned which has the result of low costs of purchase and maintenance.

Advantagously the guide wall is aligned vertically or inclined at an angle with respect to a flow direction of the air bubbles. In this manner the rising air bubbles may be controllingly guided into a desired flow direction. Advantageously the air bubbles are guided from a purely vertical up-flow into an up-flow with additional horizontal speed components. The buoyancy of the air bubbles may be used for a directed propulsion of the water. Advantageously the horizontal speed components of the air bubbles propel the water into a longitudinal flow. The control of the guiding of the flow direction of the air bubbles and of the water may be freely set via the size and the length of the guide wall.

Advantageously a first guide wall is arranged on the water surface of the water basin and a second guide wall on the base of the water basin. The length of the guide walls is shorter than the depth of the water basin. Thus the flow of the air bubbles is not only guided along the guide walls but propelled water may also flow above or below the guide walls in the longitudinal direction.

For example by way of the horizontal speed components of the air bubbles the water of a water basin may be propelled through the aeration field and uniformly aerated with oxygen. Advantageously the whole water of a circulation basin may be propelled by an aeration field. By way of this on aerating the water, mechanically actuated stirring appparatus provided for propelling the water may at least be partly done away with, which leads to energy and cost savings.

By way of the flow at various water depths there is effected a particularly intensive forced through-mixing of all water basin components, such as basin contents, incoming waste water and activated sludge. Also short-cicuit flows are avoided, that is to say pure surface flows of mixed-in waste water, by which means this mixed-in waste water does not or hardly mixes with the other water basin components.

Advantageously the guide wall is of one part or several parts and comprises lamellae. Advantageously the guide wall is arranged rigid or pivotable with respect to a flow direction of the air bubbles or is arranged insertable into the water. A pivotable or insertable guide wall permits a situational adaptation or selection of the desired flow direction. For example thus the flow direction may be varied according to the level or quality of the water.

The invention is hereinafter described in more detail in the following in embodiment examples and by way of the drawings 1 to 6. There are shown in:

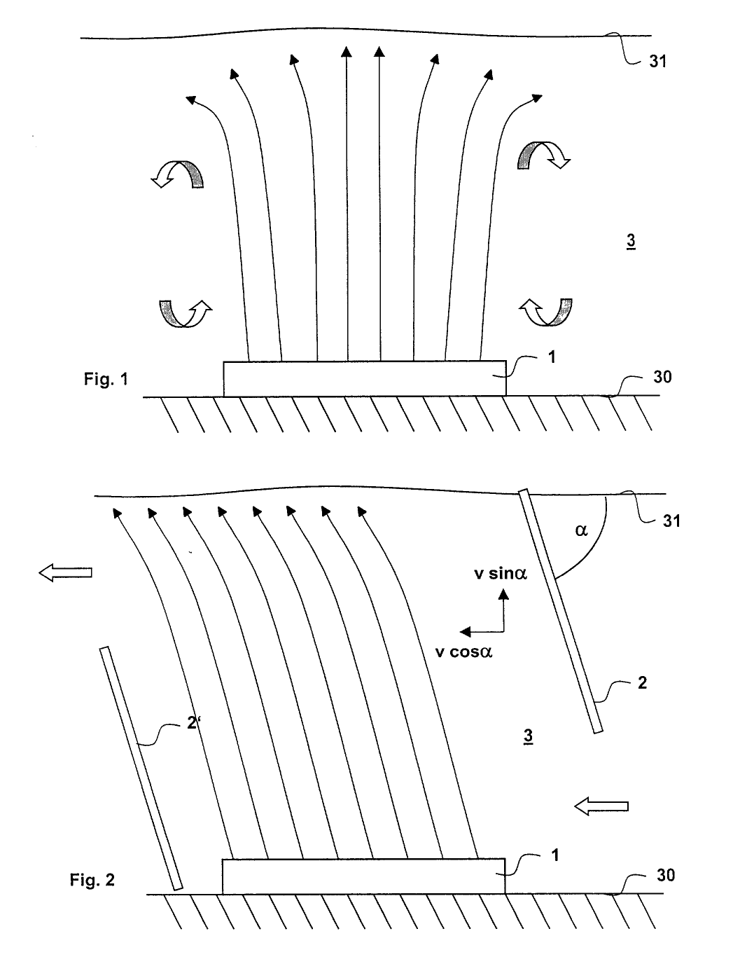

FIG. 1 a schematic perspective representation of a water basin in which rolling currents form at the edge of an aeration field,

FIG. 2 a schematic perspective representation of a water basin with an aeration device which prevents the formation of rolling currents by way of guide walls,

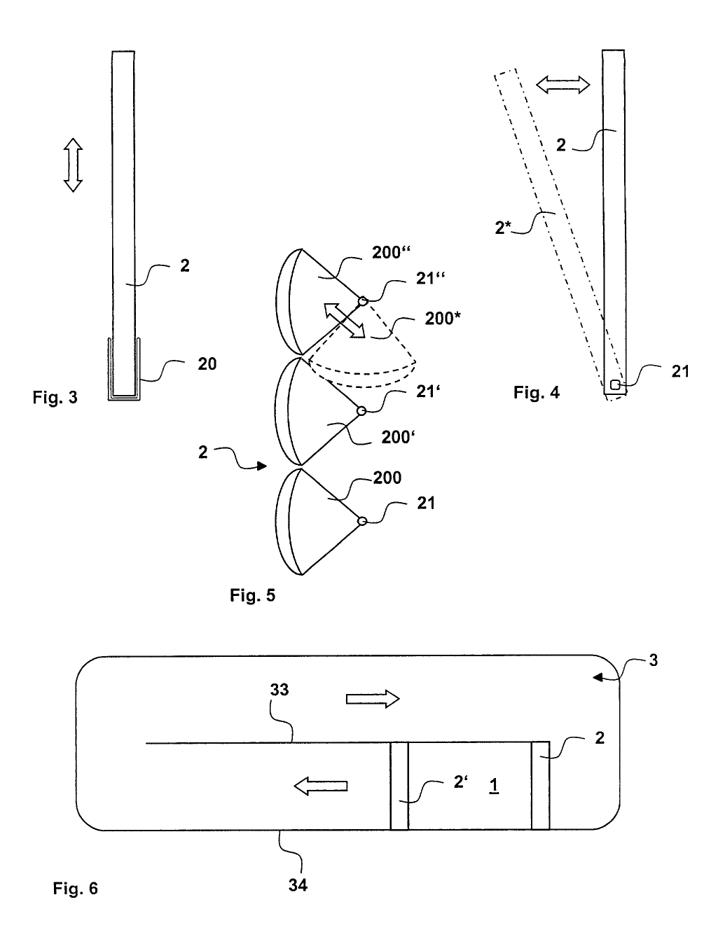

FIG. 3 a perspective representation of a first exemplary embodiment form of a guide wall insertable into a water basin,

FIG. 4 a perspective representation of a second exemplary embodiment form of a pivotable guide wall,

FIG. 5 a perspective representation of a third exemplary embodiment form of a multi-part guide wall with lamellae and

FIG. 6 a schematic perspective representation of an exemplary embodiment form of a water basin with an aeration device which produces a longitudinal flow of the water.

FIG. 1 shows in a schematic perspective representation of a part of a water basin 3 the formation of rolling currents at the edge of an aeration field. The water basin is filled with water and has a water surface 31. Advantageously on the base 30 of the water basin 3 there is assembled at least one aerator 1. The aerator 1 introduces air bubbles into the water. Often there are applied several long, tubular aerators placed parallel to one another or plate aerators, or there are used a multitude of aeration plates.

The exiting air bubbles on account of their density which is lower compared to water rise upwards against gravity and above the aerator form an aeration field. The local flow direction of the air bubbles is represented by elongate flow arrows. By way of the buoyancy of the rising air bubbles the water is laterally displaced. At the edge of the aeration fields the water forms rolling currents which non-uniformly fan out the up-flow of the air bubbles. These rolling currents are represented by short broad flow arrows. By way of these rolling currents a desired uniform aeration of the waste water, that is to say supply with oxygen, is prevented.

FIG. 2 shows a schematic perspective representation of a part of a water basin 3 according to the description to FIG. 1, but with an aeration device which prevents the formation of rolling currents by way of at least one guide wall 2. The air bubbles exiting at the aerator 1 rise in a uniform up-flow. The uniformity of the up-flow is on the one hand represented by the mutual distance of the elongate flow arrows, said mutual distance only varying slightly. The uniformity of the up-flow is on the other hand represented by the largely equal direction of the flow arrows. By way of example there are arranged two guide walls 2, 2′ laterally at the edge of the aeration field. By way of the presence of the guide walls 2, 2′ at the edge of the aeration field there is prevented a formation of rolling currents. The rising air bubbles and the water displaced by the air bubbles are guided along the guide walls 2, 2′. The guide walls 2, 2′ prevent the water from forming rolling currents.

Advantageously the guide wall 2, 2′ is aligned vertically or inclined at an angle with respect to a flow direction of the air bubbles. In this manner the rising air bubbles may be controlledly guided into a desired flow direction. For guiding the up-flow a single guide wall 2 is sufficient. As is shown by way of example in the representation of the water basin 3 according to FIG. 2, air bubbles are advantageously guided from a purely vertical up-flow into an up-flow with additional horizontal speed components. In the embodiment by way of example according to FIG. 2, the air bubbles flow parallel between two slantingly standing guide walls 2, 2′. The flow direction of the air bubbles is not purely vertical (opposing gravity), but has additional horizontal speed components corresponding to the slanted position of the guide walls 2, 2′. The slanted position of the guide walls 2, 2′ is equal to the angle α between the water surface 31 and the longitudinal axis of the guide walls 2, 2′. Accordingly v sinα is the speed component of the purely vertical up-flow of the air bubbles and v cosα indicates the horizontal speed component of the air bubbles.

The buoyancy of the air bubbles may thus be used for a directed propulsion of the water. Advantageously the horizontal speed components of the air bubbles propel the water into a longitudinal flow. The direction of the thus produced longitudinal flow of the water is represented by the elongate and short flow arrows. The control of the guiding of the flow direction may be freely set via the size or the length of the guide wall 2, 2′. For guiding the up-flow a single guide wall 2 is sufficient. As is shown in the representation of the water basin 3 according to FIG. 2 by way of example advantageously a first guide wall 2 is arranged on or below the water surface 31 of the water basin 3 and a second guide wall 2′ is arranged on the base 30 of the water basin 3. The length of the guide walls 2, 2′ is shorter than the depth of the water basin, thus the second guide wall 2′ reaches from the base 30 up to into a middle depth region of the water basin and the first guide wall 2 reaches from the middle depth region of the water basin up to the water surface 31. Thus the flow of the air bubbles is not only guided along the guide walls 2, 2′ but propelled water may also flow above or below the guide walls 2, 2′ in the longitudinal direction. Advantageously water flows at the base 30 of the water basin 3 below the first guide wall 2 into the aeration field and flows, after it has been propelled by the air bubbles, at the water surface 31 above the second guide wall 2′ out of the aeration field. In the embodiment example according to FIG. 2 the water is to flow only in one direction, specifically to the right. The first guide wall 2 projects up to the water surface 31 in order thus to prevent the water from flowing in an undesired direction, specifically to the left, on account of the the water propelled by way of the buoyancy of the air bubbles.

The guide wall consists of any material adapted to the conditions in a water basin or waste water basin. Advantageously the guide wall consists of concrete, plastic such as polypropylene, natural material such as wood or stone, or also of coated textiles. Preferably solid and rigid materials will not change their shape or only slightly under the influence of external forces occuring in the water basin or waste water basin. Advantageously the guide wall is manufactured in a light-weight construction manner in order to be simply and rapidly assembled. Advantageously the guide wall is flat, that is to say of a low depth.

The guide wall may consist of several part guide walls which are loosely or rigidly connected to one another. For example ten 2×2 meter large part guide walls may be combined into a 20×2 meter large, multi-piece guide wall. The guide wall may be straight-lined or curved. The guide wall may comprise a closed surface or a surface provided with perforations. The guide wall may comprise a smooth or rough surface. To the man skilled in the art there thus is available with the knowledge of the present invention various possibilities of designing the guide walls.

FIG. 3 shows a perspective representation of a first exemplary embodiment form of a guide wall 2 insertable into a water basin. The guide wall 2 may be inserted into a mounting 20 attached in the water basin and is held by this mounting 20 in its position and alignment. Advanatageously the guide wall is releasably fixed in the mounting 20, that is to say it may be removed from the mounting 20. The directions of the insertion or removal of the guide wall 2 into and out of the mounting are represented with a double arrow. With the knowledge of the present invention there are freely available to the man skilled in the art other mechansims for inserting the guide wall into a water basin.

FIG. 4 shows a perspective representation of a second exemplary embodiment form of a pivotable guide wall 2. The guide wall 2 is pivotable about a joint 21. FIG. 4 shows a guide wall 2 which is pivoted into a position 2*. The directions of the pivoting of the guide wall 2 about a joint 21 are represented with a double arrow. With the knowledge of the present invention the man skilled in the art may realise other mechanisms for pivoting a guide wall in a water basin.

FIG. 5 shows a perspective representation of a third exemplary embodiment form of a multi-part guide wall 2, consisting of several pivotable lamellae 200, 200′, 200″. Each lamella 200, 200′, 200″ is pivotable about a joint 21, 21′, 21″. In the exemplary embodiment form according to FIG. 5 a middle lamela 200′ is pivoted into a position 200*. The directions of the pivoting of the lamellla 200′ about a joint 21′ are represented with a double arrow.

FIG. 6 shows a schematic, perspective representation of an exemplary embodiment form of a water basin 3 in the form of a circulation basin or circulation ditch and with a middle separating wall 33. Only in one part of the water basin is there provided an aeration device of the exemplary embodiment form according to FIG. 2. Here above at least one aerator 1 there is produced an aeration field. Two guide walls 2, 2′ prevent the formation of rolling currents and guide the air bubbles into an up-flow with horizontal speed components. The guide walls 2, 2′ extend from an outer wall 34 of the water basin up to the middle separating wall 33.

It has been ascertained that the bouyancy of the air bubbles brings up to 10 times more energy into a circulation basin than envisaged mechanically actuated stirring apparatus. By way of the prevention of rolling currents, and the guiding of the air bubbles into an up-flow with horizontal speed components, this energy may be exploited for propelling the water into a longitudinal direction. Advantageously the whole water of the circulation basin is propelled through the aeration field and thus supplied with oxygen. Also here thus the actual function of the stirring apparatus is fullfilled, specifically of keeping the mud particles in suspense. As is represented by two short flow arrows in the embodiment example according to FIG. 6 the water flows in the clockwise direction around the middle separating wall 33. Thus on aerating the water the mechanically actuated stirring apparatus provided for propelling the water may be completely or at least partly done away with. As is represetnted by two short flow arrows in the embodiment example according to FIG. 6, the water flows in the clockwise direction around the middle separating wall 33.

Advantageously, as as shown with the embodiment example according to FIG. 2, the water flows, guided by the guide wall 2, 21, into various water depths, that is to say below the first guide wall 2, close to the base of the water basin 3, into the aeration field and above the second guide wall 2′, close to the water surface of the water basin, out of the aeration field. By way of this flow, in various water depths there is effected a particularly intensive forced through-mixing of all water basin components, such as basin contents, incoming waste water and activated sludge. Thus short-circuit flows are avoided, that is to say pure surface flows of mixed-in water, by which means this mixed-in water does not mix or hardly mixes with the other water basin components. The position of guide walls is thus not limited to the region of the aeration field, but guide walls may in principle be used in the whole water basin for the directed guiding of a flow.

1. An aeration device for water, comprising at least one aerator assembled in d water basin for introducing air bubbles in the water, said air bubbles rising in the water and forming an aeration field, whereby at least one guide wall is provided guiding the up-flow of the air bubbles.

2. An aeration device according to claim 1, whereby the guide wall is arranged laterally on the edge of the aeration field.

3. An aeration device according to claim 1 whereby the guide wall is aligned vertically or inclined with respect to a flow direction of the air bubbles.

4. An aeration device according to claim 3, whereby the guide wall is arranged rigidly or pivotably.

5. An aeration device according to the claim 1, whereby the guide wall (2) comprises several pivotable lamellae.

6. An aeration device according the claim 1, whereby the guide wall may be applied on a base (30) of the water basin or on a water surface (31) of the water basin.

7. An aeration device according to the claim 1, whereby the guide wall guides air bubbles into a vertical up-flow with horizontal speed components.

8. A method for aerating water, using at least one aerator assembled in a water basin, for introducing air bubbles into water, said air bubbles rising in the water and forming an aeration field, whereby the up-flow of the air bubbles is guided by way of at least one guide wall.

9. A method for aerating water according to claim 8, whereby the air bubbles are guided into a vertical up-flow with horizontal speed components.

10. A method for aerating water according to claim 9, whereby the water is propelled into a longitudinal flow by way of the air bubbles with horizontal speed components and that the water is propelled by an aeration field formed only in one part of a water basin (3).

11. A method for aerating water according to claim 8, whereby water is guided by the guide wall in various water depths.
